(19) United States
(12) Patent Application Publication
(10) Pub. No.: US 2011/0110008 A1
(43) Pub. Date: May 12, 2011

(54) OVER CURRENT PROTECTION CIRCUIT

(75) Inventor: WEN-YUNG LIAO, Tu-Cheng (TW)

(73) Assignee: HON HAI PRECISION INDUSTRY CO., LTD., Tu-Cheng (TW)

(21) Appl. No.: 12/650,792

(22) Filed: Dec. 31, 2009

(30) Foreign Application Priority Data
Nov. 11, 2009 (CN) 200910309532.2

(51) Int. Cl. H02H 3/027

(52) U.S. Cl. 361/91.3

(57) ABSTRACT

An over current protection circuit controls connection and disconnection of an electronic device. When the electronic device is turned off because of over current, the over current protection circuit automatically resets the electronic device after a delay time.

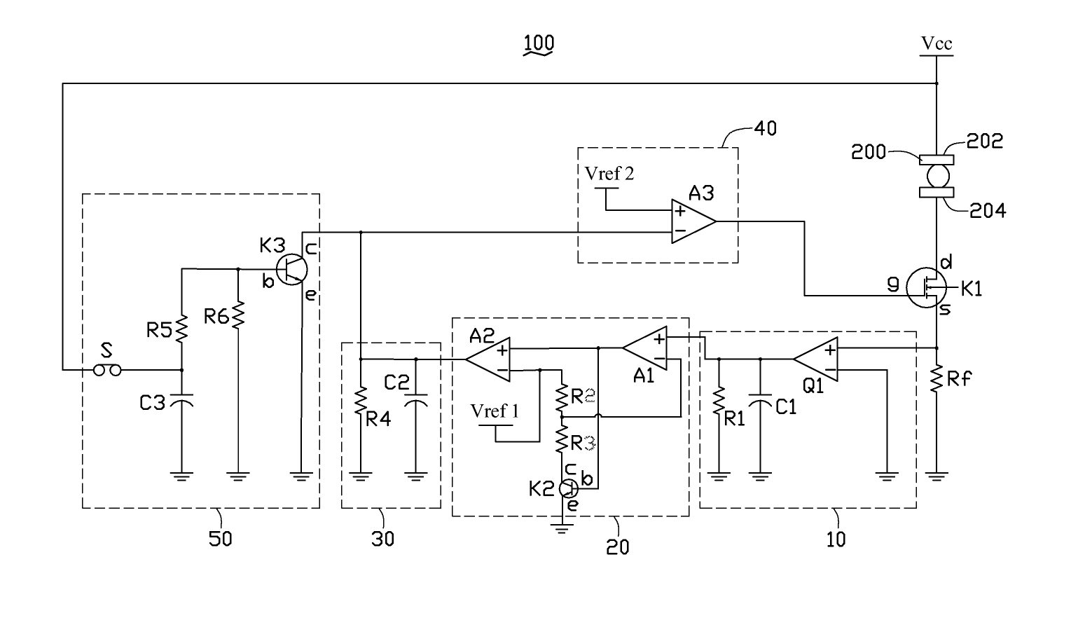

### BACKGROUND

1. Technical Field

The present disclosure relates to over current protection circuits, and particularly, to an over current protection circuit with an automatically reset capability.

2. Description of Related Art

Over current protection circuits have been extensively applied to electronic devices to protect the electronic devices from being damaged in case of excessive current. Generally, when the current in the electronic device exceeds a safe level, the over current protection circuit opens the circuit of the electronic device. However, current over current protection circuits typically do not automatically reset. As such, it is inconvenient to use over current protection circuits.

Therefore, an over current protection circuit which can overcome the above-described problems is desirable.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the present embodiments.

The FIGURE is a circuit diagram of an over current protection circuit for an electronic device in accordance with an exemplary embodiment.

### DETAILED DESCRIPTION

Embodiments of the disclosure are now described in detail with reference to the drawing.

Referring to the FIGURE, an over current protection circuit 100, according to an exemplary embodiment, is configured to provide over current protection to an electronic device 200. The electronic device 200 includes an input terminal 202 connected to a power source Vcc and an output terminal 204. In one non-limiting embodiment, the electronic device 200 is a fan, but the disclosure is not limited thereto.

The over current protection circuit 100 includes a switching element K1, a voltage dividing resistor Rf, a voltage detecting circuit 10, a pulse generation circuit 20, a RC discharging circuit 30, a comparison circuit 40, and a force restart circuit 50.

The switching element K1 includes a first terminal d, a second terminal s, and a control terminal g. The control terminal g is used to control connection and disconnection between the first terminal d and the second terminal s. The first terminal d is coupled to the output terminal 204 of the electronic device 200. The second terminal s is grounded via the voltage dividing resistor Rf. In this embodiment, the switching element K1 is a p-channel metal oxide semiconductor (PMOS) transistor, wherein the first terminal d is the drain, the second terminal s is the source, and the control terminal g is the gate.

The voltage detecting circuit 10 includes an amplifier Q1, a first capacitor C1, and a first resistor R1. The amplifier Q1 includes a positive input terminal coupled to the second terminal s of the switching element K1, a negative input terminal that is grounded, and an output terminal. The first capacitor C1 includes a first terminal coupled to the output terminal of the amplifier Q1 and a second terminal that is grounded. The first resistor R1 includes a first terminal coupled to the output terminal of the amplifier Q1 and a second terminal that is grounded.

The pulse generation circuit 20 includes a first comparator A1, a second comparator A2, a second resistor R2, a third resistor R3, and a first transistor K2. The first comparator A1 includes a positive input terminal coupled to the output terminal of the amplifier Q1, a negative input terminal, and an output terminal. The second comparator A2 includes a positive input terminal coupled to the output terminal of the first comparator A1, a negative input terminal coupled to a first reference voltage Vref1, and an output terminal. The second resistor R2 includes a first terminal coupled to the negative input terminal of the second comparator A2 and a second terminal coupled to the negative input terminal of the first comparator A1. The third resistor R3 includes a first terminal coupled to the negative input terminal of the first comparator A1 and a second terminal. The first transistor K2 is a pnp transistor of which the collector c is coupled to the second terminal of the third resistor R3, the emitter e is grounded, and the base b is coupled to the output terminal of the first comparator A1.

The RC discharging circuit 30 includes a second capacitor C2 and a fourth resistor R4. The second capacitor C2 includes a first terminal coupled to the output terminal of the second comparator A2 and a second terminal that is grounded. The fourth resistor R4 includes a first terminal coupled to the output terminal of the second comparator A2 and a second terminal that is grounded.

The comparison circuit 40 includes a third comparator A3. The third comparator A3 includes a negative input terminal coupled to the output terminal of the second comparator A2, a positive input terminal coupled to a second reference voltage Vref2, and an output terminal coupled to the control terminal of the switching element K1.

The force restart circuit 50 includes a monopole single throw switch S, a third capacitor C3, a fifth resistor R5, a sixth resistor R6, and a second transistor K3. The monopole single throw switch S includes a first terminal coupled to the power source Vcc and a second terminal. The third capacitor C3 includes a first terminal coupled to the second terminal of the monopole single throw switch S and second terminal grounded. The fifth resistor R5 includes a first terminal coupled to the first terminal of the third capacitor C3 and a second terminal. The sixth resistor R6 includes a first terminal coupled to the second terminal of the fifth resistor R5 and a second terminal grounded. The second transistor K3 is a pnp transistor of which the collector c is coupled to the negative input terminal of the third comparator A3, the emitter e is grounded, and the base b is coupled to the second terminal of the sixth resistor R6.

In a normal operating condition, the control terminal g of the switching element K1 is at a low level signal (e.g., logical “0”). Therefore, the first terminal d and the second terminal s of the switching element K1 are conducted, and the electronic device 200 is powered by the power source Vcc. The positive input terminal of the amplifier Q1 acquires a divided voltage of the voltage dividing resistor Rf. The amplifier Q1 amplifies the divided voltage and outputs the amplified divided voltage to the positive input terminal of the first comparator A1, and charges the first capacitor C1. The first comparator A1 compares the amplified divided voltage with the first reference voltage Vref1. If the amplified divided voltage is lower than the first reference voltage Vref1, then current in the electronic device 200 is at or below a predetermined safe level, and the first comparator A1 outputs a low level signal to the positive input terminal of the second comparator A2 and the base of the first transistor K2. In this embodiment, the first reference voltage Vref1 is lower than a high level signal (e.g., logical “1”) and higher than the low level signal, and the threshold voltage of the first transistor is higher than the low level signal and lower than the high level signal. The first transistor K2 remains in the cut-off state. The second comparator A2 compares the low level signal with the first reference voltage Vref1, and outputs a low level signal to the negative input terminal of the third comparator A3. In this embodiment, the second reference voltage Vref2 is lower than the high level signal and higher than the low level signal. The third comparator A3 compares the low level signal with the second reference voltage Vref2, and outputs a low level signal to the control terminal g of the switching element K1. The switching element K1 remains on.

If the amplified divided voltage exceeds the first reference voltage Vref1, then current in the electronic device 200 exceeds the predetermined safe level, the electronic device 200 is in the over current state. The first comparator A1 outputs a high level signal to the positive input terminal of the second comparator A2 and the base b of the first transistor K2. The collector c and the emitter e of the first transistor K2 are conducted. The second comparator A2 compares the high level signal with the first reference voltage Vref1, and outputs a high level signal to the negative input terminal of the third comparator A3. The third comparator A3 compares the high level signal with the second reference voltage Vref2, and outputs a high level signal to the control terminal g of the switching element K1. The switching element K1 turns off power to the electronic device 200.

After the switching element K1 turns off, the first capacitor C1 discharges quickly. As the collector and the emitter of the first transistor K2 are conducted, the voltage of the negative input terminal of the first comparator A1 is [R3/(R3+R2)]*Vref1. During the initial discharge, the discharge voltage of the first capacitor C1 is higher than the [R3/(R3+R2)]*Vref1, the first comparator A1 outputs a high level signal to the positive input terminal of the second comparator A2. The second comparator A2 compares the high level signal with the first reference voltage Vref1, and outputs a high level signal. Then, the second capacitor C2 is charged by the high level signal. When the discharge voltage of the first capacitor C1 is lower than the [R3/(R3+R2)]*Vref1, the first comparator A1 outputs a low level signal to the positive input terminal of the second comparator A2 and the base b of the first transistor K2 simultaneously. The first transistor K2 turns off. The second comparator A2 compares the low level signal with the first reference voltage Vref1, and outputs a low level signal. Then, the second capacitor C2 generates a discharging voltage to the negative input terminal of the third comparator A3. The third comparator A3 compares the discharging voltage with the second reference voltage Vref2. When the discharging voltage of the second capacitor is lower than the second reference voltage Vref2, the third comparator A3 outputs a low level signal to the control terminal g of the switching element K1. The switching element K1 turns on again, and the electronic device 200 receives power.

Alternatively, when power supply of the electronic device 200 is turned off by the over current protection circuit 100, a user can turn off the monopole single throw switch S. Then, the second transistor K3 turns on, and the collector of the second transistor K3 is grounded. The output terminal of the third comparator A3 output a low level signal. The switching element K1 turns on, and the electronic device 200 receives power again.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. An over current protection circuit comprising:
a switching element comprises a first terminal coupled to an electronic device, a second terminal grounded via a voltage dividing resistor, and a control terminal used to control connection and disconnection between the first terminal and the second terminal;
a voltage detecting circuit coupled to the second terminal of the switching element, the voltage detecting circuit to generate a discharging voltage when the switching element turns off;
a pulse generation circuit connected with the voltage detecting circuit, pulse generation circuit to generate a high level signal and a low level signal according to the discharging voltage;
a RC discharging circuit connected with the pulse generation circuit, and charged by the high level signal, the RC discharging circuit to discharge when the pulse generation circuit generates the low level signal; and
a comparison circuit connected between the RC discharging circuit and the control terminal of the switching element, wherein the comparison circuit generates a low level signal to turn on the switching element when the discharging voltage of the RC discharging circuit is lower than a second reference voltage.

2. The over current protection circuit in claim 1, wherein the switching element is a p-channel metal oxide semiconductor (PMOS) transistor, wherein the first terminal is the drain, the second terminal is the source, and the control terminal is the gate.

3. The over current protection circuit in claim 1, wherein the voltage detecting circuit comprises an amplifier comprising a positive input terminal coupled to the second terminal of the switching element, a negative input terminal grounded, and an output terminal; a first capacitor comprising a first terminal coupled to the output terminal of the amplifier and a second terminal grounded; a first resistor comprising a first terminal coupled to the output terminal of the amplifier and a second terminal grounded.

4. The over current protection circuit in claim 3, wherein the pulse generation circuit comprises a first comparator comprising a positive input terminal coupled to the output terminal of the amplifier, a negative input terminal, and an output terminal; a second comparator comprising a positive input terminal coupled to the output terminal of the first comparator, a negative input terminal coupled to a first reference voltage, and an output terminal; a second resistor comprising a first terminal coupled to the negative input terminal of the second comparator and a second terminal coupled to the negative input terminal of the first comparator; a third resistor comprising a first terminal coupled to the negative input terminal of the first comparator and a second terminal; a first transistor comprising a collector coupled to the second terminal of the third resistor, an emitter grounded, and a base coupled to the output terminal of the first comparator.

5. The over current protection circuit in claim 4, wherein the RC discharging circuit comprises a second capacitor comprising a first terminal coupled to the output terminal of the second comparator and a second terminal grounded; a fourth resistor comprising a first terminal coupled to the output terminal of the second comparator and a second terminal grounded.

6. The over current protection circuit in claim 5, wherein the comparison circuit comprises a third comparator comprising a negative input terminal coupled to the output terminal of the second comparator, a positive input terminal coupled to a second reference voltage, and an output terminal coupled to the control terminal of the switching element.

7. An over current protection circuit comprising:
a switching element comprises a first terminal coupled to an electronic device, a second terminal grounded via a voltage dividing resistor, and a control terminal used to control connection and disconnection between the first terminal and the second terminal;
a voltage detecting circuit coupled to the second terminal of the switching element, the voltage detecting circuit to generate a discharging voltage when the switching element turns off;
a pulse generation circuit connected with the voltage detecting circuit, pulse generation circuit to generate a high level signal and a low level signal according to the discharging voltage;
a RC discharging circuit connected with the pulse generation circuit, and charged by the high level signal, the RC discharging circuit to discharge when the pulse generation circuit generates the low level signal;
a comparison circuit connected between the RC discharging circuit and the control terminal of the switching element, wherein the comparison circuit generates a low level signal to turn on the switching element when the discharging voltage of the RC discharging circuit is lower than a second reference voltage; and
a force restart circuit connected with the comparison circuit, the force restart circuit to control the comparison circuit to output the low level signal.
